(19) United States
(12) Patent Application Publication
(10) Pub. No.: US 2024/0237598 A1
(43) Pub. Date: Jul. 18, 2024

(54) CONTROLLED ENVIRONMENT AGRICULTURAL GROW OPERATION

(71) Applicant: M&J Agronomics LLC, Veneta, OR (US)

(72) Inventors: James Gill, Greensboro, GA (US); Mark Branum, North Augusta, SC (US)

(73) Assignee: M&J Agronomics LLC, Veneta, OR (US)

(21) Appl. No.: 18/411,491

(22) Filed: Jan. 12, 2024

Related U.S. Application Data
(60) Provisional application No. 63/480,229, filed on Jan. 17, 2023.

(51) Int. Cl. A01G 31/06

(52) U.S. Cl. CPC A01G 31/06

(57) ABSTRACT

Embodiments relate to a system for growing plants in a controlled environment. The system includes one or more buildings, each building comprising a plurality of growing pods (e.g., a box-like structure, such as a shipping container), wherein each growing pod comprises an irrigation system. The system further comprises a central environment system, wherein the central environment system is configured to control environmental conditions of the plurality of growing pods. The growing pods may be modular in design such that the system may be expanded in a modular manner.

### CROSS-REFERENCE TO RELATED APPLICATIONS

This application claims priority to U.S. Provisional Patent Application No. 63/480,229, which was filed on Jan. 17, 2023. The entirety of this application is incorporated by reference herein.

### FIELD OF THE INVENTION

Embodiments relate to an agricultural grow operation, particularly to a grow operation incorporating modular growing pods with controlled environments.

### BACKGROUND OF THE INVENTION

Traditional farming (i.e., field farms) typically need a lot of space in order to grow sufficient product to harvest and sell. Accordingly, expanding a traditional farm is a costly and time-consuming process. Traditional farms further heavily rely on natural environmental conditions, which cannot be optimized to ensure ideal growth conditions.

There is therefore an everlasting need for alternative solutions to field farming, particularly for solutions that maximize available square footage of a given land space (i.e., more yield per square foot), support a more efficient expansion process, and enable the control environmental conditions to promote maximum product yield.

### SUMMARY OF THE INVENTION

Embodiments relate to a system for growing plants in a controlled environment. The system may include one or more buildings, each building comprising a plurality of growing pods with plants. A growing pod may be a box-like structure to support a modular design and efficient expansion/stacking, thus allowing farmers to maximize yield per square foot of land. The growing pod may be built from reengineered, repurposed, and/or recycled structures, such as a reengineered shipping container (e.g., standard 20-foot or 40-foot shipping container).

In an exemplary embodiment, a system for growing plants comprises one or more buildings, each building comprising a plurality of growing pods, wherein each growing pod comprises an irrigation system, and a central environment system, wherein the central environment system is configured to control one or more environmental conditions of each growing pod; wherein each growing pod is a shipping container.

In some embodiments, the plants are cannabis plants.

In some embodiments, the shipping container is a recycled shipping container.

In some embodiments, the growing pods are modular in design such that a second growing pod is configured to be stacked on a first growing pod.

In some embodiments, the one or more buildings comprise a catwalk or mezzanine to provide access to the stacked growing pods.

In some embodiments, a third growing pod is configured to but the first growing pod.

In some embodiments, the growing pods are arranged completely within the one or more buildings.

In some embodiments, the growing pods are arranged partially within the one or more buildings.

In some embodiments, the one or more environmental conditions is selected from the group consisting of temperature, humidity, and combinations thereof.

In some embodiments, the irrigation system is configured to deliver water to the growing pods.

In some embodiments, the irrigation system comprises sensors configured to monitor moisture and nutrient levels.

In some embodiments, the irrigation system comprises computerized controls, wherein the computerized controls and sensors are configured to cooperate to maintain pre-determined monitor moisture and nutrient levels.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1 shows a perspective view of an exemplary system for growing plants in a controlled environment.

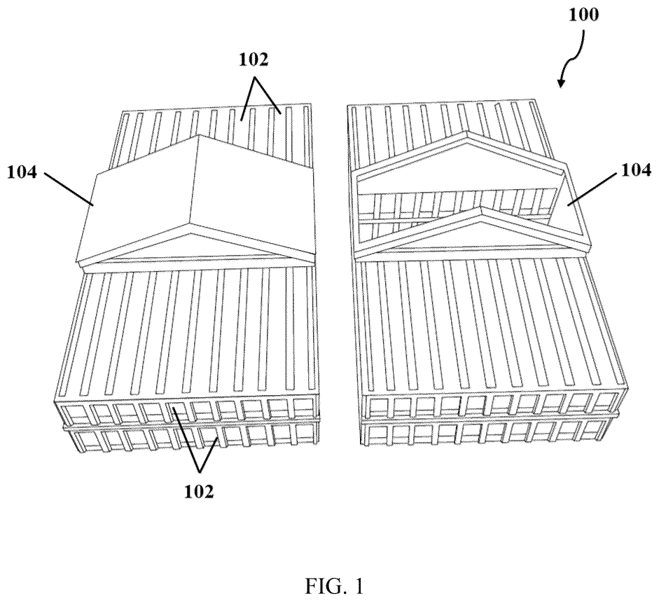

FIG. 2 shows a side view of an exemplary system for growing plants in a controlled environment.

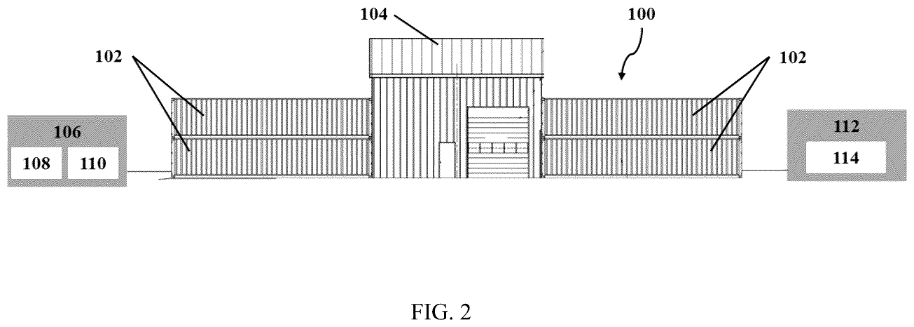

FIG. 3 shows a front view of an exemplary system for growing plants in a controlled environment.

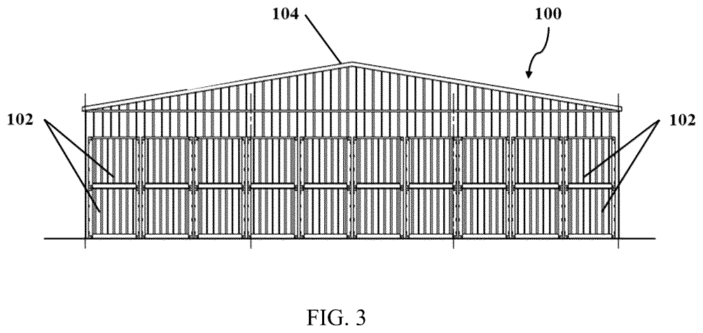

FIG. 4 shows exemplary growing pods.

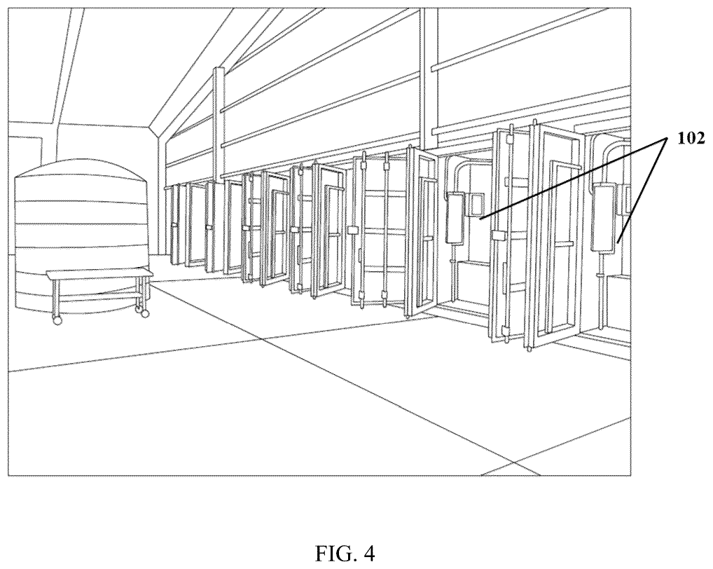

FIG. 5A shows a top view of a first level of an exemplary system for growing plants in a controlled environment.

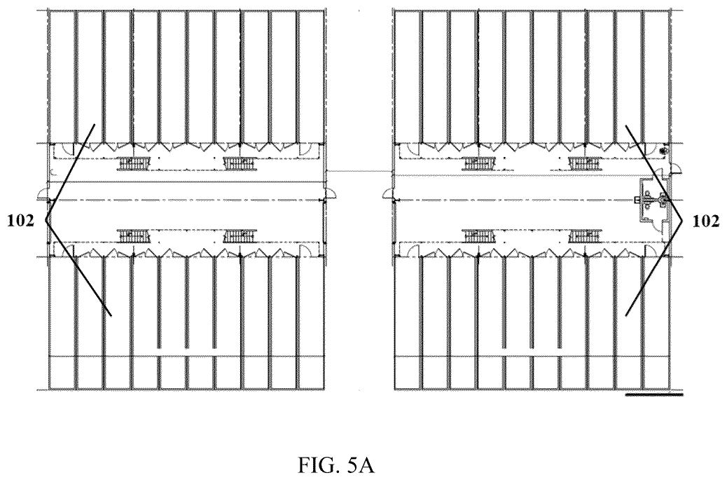

FIG. 5B shows a top view of a second level of an exemplary system for growing plants in a controlled environment.

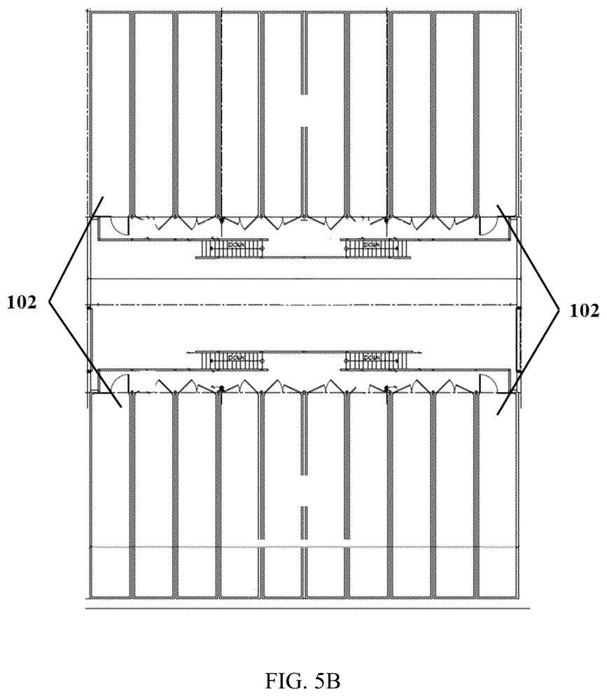

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of various aspects of the present invention. The scope of the present invention is not limited by this description.

Embodiments relate to a system 100 for growing plants in a controlled environment. The system may comprise a plurality of growing pods 102. The growing pods 102 comprise one or more plants. It is contemplated that a growing pod 102 may be a box-like structure. In a preferred embodiment, the growing pod 102 may be built from reengineered, repurposed, and/or recycled structures, such as a reengineered shipping container or a reengineered box trailer. For example, a standard 20-foot or 40-foot shipping container may be used as a growing pod 102. A person having ordinary skill in the art will recognize that structures of other sizes may alternatively be used as a growing pod 102 for constructing the herein disclosed system 100 for growing plants in a controlled environment. The system 100 can be a system that requires minimal infrastructure to begin operation and use.

The growing pod 102 may be modular in design such that the system may be expanded in a modular manner. For example, the system may be configured to expand vertically by stacking a second growing pod on a first growing pod, a third growing pod on the second growing pod, etc., and/or the system may be configured to expand horizontally by abutting a second growing pod to a first growing pod, a third growing pod to the second growing pod, etc. It is contemplated that a vertical connection mechanism may be used to facilitate stacking of the growing pods, wherein the vertical connection mechanism may be positioned between the growing pods. It is further contemplated that a horizontal connection mechanism may be used to facilitate abutting the growing pods, wherein the horizontal connection mechanism may be positioned between the growing pods. It is contemplated that a modular design advantageously permits efficient layout of controls, service utilities, and overall ease of operation.

The system 100 may comprise one or more buildings 104 wherein each building 104 comprises one or more growing pods 102. For example, in an embodiment wherein the growing pods 102 are shipping containers, each building 104 may comprise one or more shipping containers. It is contemplated that the growing pods 102 may be arranged completely within the building 104, or arranged partially (i.e., not completely) within the building 104. In a preferred embodiment, only a front portion of the growing pod 102 is arranged within the building 104 such that remaining portion of the growing pod 102 is positioned exterior to the building 104. For example, in an embodiment wherein the growing pod 102 is a shipping container, only the front entry of the container (i.e., the end of the shipping container that may be opened) may be physically located within the building 104. Such an embodiment may advantageously allow for a more modest building 104 to house the entire system 100.

As it is contemplated that a growing pod 102 may be modular in design such that the system 100 may be expanded in a modular manner, it is contemplated that a building 104 may comprise stacked growing pods 102 and/or growing pods abutting other growing pods 102. Such a configuration advantageously allows for multiple growing pods 102 to be situated in the same building/property, thus maximizing square footage available in a given land space.

As it is contemplated that a building 104 may comprise stacked growing pods 102, the building may comprise one or more catwalks and/or one or more mezzanines to provide access to stacked growing pods 102 and one or more levels (i.e., a first level, second level, third level, etc.) of a building 104.

The growing pod 102 may have insulation material on the walls and/or ceiling of the growing pod 102. The insulation material may advantageously provide a thermal break between the walls and/or ceiling and the interior of the growing pod 102. The insulation material may further fill corrugations within the walls and/or ceiling. It is contemplated that the insulation material may be one or more foam panels. For example, the insulation material may be a plurality of polystyrene foam panels (e.g., ½ inch thick, 2 inches thick, etc.). The insulation material may be held in place on the walls and/or ceiling with T-slot aluminum rails.

The system 100 may further comprise a central environment system 106. The central environment system 106 is configured to control the environmental conditions (e.g., temperature, humidity, etc.) of each growing pod 102. The central environment system 106 may be located outside of the building 104 and/or within the building 104. The central environment system 106 may comprise a plurality of heat exchangers 108 and a plurality of air handler units 110, wherein each growing pod 102 may comprise a heat exchanger 108 and an air handler unit 110. The heat exchanger 108 and the air handler unit 110 may be located within the growing pod 102, outside the growing pod 102, on top of the growing pod 102, or next to the growing pod 102, to increase space, efficiency, and/or ease of access.

The system 100 may further comprise an irrigation system 112. The irrigation system 112 is configured to deliver water and/or fertilizer to plants within the growing pod 102. It is contemplated that each growing pod 102 may comprise an irrigation system 112. The irrigation system 112 may comprise sensors to monitor moisture and nutrient levels. The irrigation system 112 may further comprise computerized controls, wherein the controls and sensors cooperate to support pre-determined or ideal moisture and/or nutrient levels with minimal human intervention.

The irrigation system 112 may comprise a plurality of capillary tubes to deliver water from a water storage system to the plants within the growing pods. It is contemplated that each plant may have a capillary tube.

The irrigation system 112 may comprise a water storage system 114. The water storage system 114 may store water to be delivered to growing pods 102. The water storage system 114 may be located outside of the building 104 and/or within the building 104. The water storage system 114 may be temperature controlled such that the water storage system 114 may maintain a temperature range. In a preferred embodiment, the water storage system 114 may maintain a temperature range of 60-65ºF. A temperature range of 60-65ºF advantageously promotes better uptake of nutrients.

The plants may be any plant that may be traditionally farmed including, vegetable plants, fruit plants, fruit trees, cannabis plants, shrubberies, and bushes, for example. In a preferred embodiment, the plants are cannabis plants. It is contemplated that the growing pods 102 may each comprise the same plants, or the growing pods 102 may comprise any number of various plants,

In each growing pod, 102 one or more plants are grown in a hydroponic state. In a preferred embodiment, the plants are grown in a hydroponic state utilizing rockwool cubes as rooting media. The plants may be watered and fertilized at least once per day, and preferably multiple times per day. It is contemplated that drip irrigation feeding may be used to water and fertilize the plants. In a preferred embodiment drip irrigation feeding may be used to water and fertilize the plants multiple times per day, and preferably 3-4 times per day (e.g., 30-50 gallons per watering).

It is contemplated that all plants may be flushed once per week.

It is contemplated that three different types of nutrient blends may be fed to the plants throughout the plant's lifecycle. It is contemplated that three different types of nutrient blends advantageously maximized yield.

It is contemplated that plants may be dried for six days before trimming and/or harvesting.

It is further contemplated that plants may be trimmed as quickly as possible to ensure a consumer may have a final product within one month from harvesting.

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of the device and methods of making and using the same have been discussed and illustrated herein, it is to be distinctly understood that the invention is not limited thereto but may be otherwise variously embodied and practiced within the scope of the following claims.

What is claimed is:

1. A system for growing plants, comprising:
one or more buildings, each building comprising a plurality of growing pods, wherein each growing pod comprises an irrigation system, and
a central environment system, wherein the central environment system is configured to control one or more environmental conditions of each growing pod;
wherein each growing pod is a shipping container.

2. The system of claim 1, wherein the plants are cannabis plants.

3. The system of claim 1, wherein the shipping container is a recycled shipping container.

4. The system of claim 1, wherein the growing pods are modular in design such that a second growing pod is configured to be stacked on a first growing pod.

5. The system of claim 4, wherein the one or more buildings comprise a catwalk or mezzanine to provide access to the stacked growing pods.

6. The system of claim 4, wherein a third growing pod is configured to but the first growing pod.

7. The system of claim 1, wherein the growing pods are arranged completely within the one or more buildings.

8. The system of claim 1, wherein the growing pods are arranged partially within the one or more buildings.

9. The system of claim 1, wherein the one or more environmental conditions is selected from the group consisting of temperature, humidity, and combinations thereof.

10. The system of claim 1, wherein the irrigation system is configured to deliver water to the growing pods.

11. The system of claim 10, wherein the irrigation system comprises sensors configured to monitor moisture and nutrient levels.

12. The system of claim 11, wherein the irrigation system comprises computerized controls, wherein the computerized controls and sensors are configured to cooperate to maintain pre-determined monitor moisture and nutrient levels.
